(19) United States
(12) Patent Application Publication
(10) Pub. No.: US 2024/0417287 A1
(43) Pub. Date: Dec. 19, 2024

(54) ENHANCED ELECTRO-OXIDATION SYSTEM

(71) Applicant: Lummus Technology LLC, Houston, TX (US)

(72) Inventors: Mark Allen Clark, Wausau, WI (US); Bryan J. Kumfer, Ringle, WI (US); Chad L. Felch, Kronenwetter, WI (US)

(21) Appl. No.: 18/702,843

(22) PCT Filed: Oct. 17, 2022
(86) PCT No.: PCT/US2022/046864

§ 371 Date: Apr. 19, 2024

Related U.S. Application Data
(60) Provisional application No. 63/270,220, filed on Oct. 21, 2021.

(51) Int. Cl. C02F 1/467; B01D 61/02; B01D 61/08; C02F 1/44; C02F 1/461; C02F 101/34; C02F 103/02

(52) U.S. Cl. CPC C02F 1/4672; B01D 61/025; B01D 61/08; C02F 1/441; C02F 1/46109; B01D 2311/08; C02F 2001/46147; C02F 2101/34; C02F 2103/023; C02F 2201/4618; C02F 2301/046

(57) ABSTRACT

A method of treating a quantity of water that includes a first level of a contaminant and is discharged from a process includes mixing the water with an effluent having a second level of the contaminant to produce a condensate having a third level of contaminant, the second level being greater than the first level. The method further includes passing the condensate through a reverse osmosis system to produce a permeate having a fourth level of the contaminant and a concentrate having a fifth level of the contaminant that is greater than the fourth level. The method also includes oxidizing the concentrate in an electro-oxidation system to generate the effluent and directing the effluent to a point upstream of the reverse osmosis system to perform the mixing step.

### BACKGROUND

Water sources including surface water, Wastewater, process waters and drinking water often include undesirable contaminants. The contaminates may result in or include very difficult to treat compounds with high chemical oxygen demand (COD), hazardous inhibitory and/or biorefractory chemicals. Many of these compounds are hazardous at low level (ppm, ppb, ppt, etc.) concentrations. The kinetics and stoichiometry required to destroy or remove these types of contaminants are not normally economically favorable. The most challenging constituents can include things like PFAS, Dioxins, Pesticides, Active Pharmaceutical Ingredients for examples. Standard biological wastewater treatment technologies simply cannot effectively treat these compounds and standard advanced oxidation processes are simply too inefficient or costly.

### SUMMARY

In one aspect, a treatment system operable to treat a flow of water includes a reverse osmosis system operable to separate the flow of water into a permeate that has a first level of a contaminant, and a concentrate that has a second level of the contaminant that is higher than the first level of the contaminant. An electro-oxidation system is positioned to receive the concentrate and operates to reduce the level of the contaminant in the concentrate using an electro-oxidation process and to discharge an effluent having a third level of the contaminant that is lower than the second level of the contaminant. An effluent return line is positioned to direct the effluent from the electro-oxidation system to an inlet to the reverse osmosis system, the effluent mixing with the flow of water prior to entry into the reverse osmosis system.

In another aspect, a method of treating a quantity of water that is discharged from a process includes mixing the water with an effluent to produce a condensate, directing the condensate into a reverse osmosis system, and separating the condensate into a permeate having a first level of a contaminant and a concentrate having a second level of the contaminant that is greater than the first level of the contaminant. The method also includes directing the concentrate to an electro-oxidation system, applying an electrical current to the concentrate to oxidize a portion of the contaminant and generate the effluent having a third level of the contaminant that is lower than the second level of the contaminant. The method further includes directing the effluent to a point upstream of the reverse osmosis system.

In another aspect, a method of treating a quantity of water that includes a first level of a contaminant and is discharged from a process includes mixing the water with an effluent having a second level of the contaminant to produce a condensate having a third level of contaminant, the second level being greater than the first level. The method further includes passing the condensate through a reverse osmosis system to produce a permeate having a fourth level of the contaminant and a concentrate having a fifth level of the contaminant that is greater than the fourth level. The method also includes oxidizing the concentrate in an electro-oxidation system to generate the effluent and directing the effluent to a point upstream of the reverse osmosis system to perform the mixing step.

### BRIEF DESCRIPTION OF THE DRAWINGS

To easily identify the discussion of any particular element or act, the most significant digit or digits in a reference number refer to the figure number in which that element is first introduced.

FIG. 1 is a schematic illustration of an electro-oxidation system.

FIG. 2 is a schematic illustration of an enhanced electro-oxidation treatment system.

### DETAILED DESCRIPTION

Before any embodiments of the invention are explained in detail, it is to be understood that the invention is not limited in its application to the details of construction and the arrangement of components set forth in this description or illustrated in the following drawings. The invention is capable of other embodiments and of being practiced or of being carried out in various ways. Also, it is to be understood that the phraseology and terminology used herein is for the purpose of description and should not be regarded as limiting.

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

It should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Furthermore, while multiple embodiments or constructions may be described herein, any features, methods, steps, components, etc. described with regard to one embodiment are equally applicable to other embodiments absent a specific statement to the contrary.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean that an element is relatively near to but not in contact with a further element or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard is available, a variation of twenty percent would fall within the meaning of these terms unless otherwise stated.

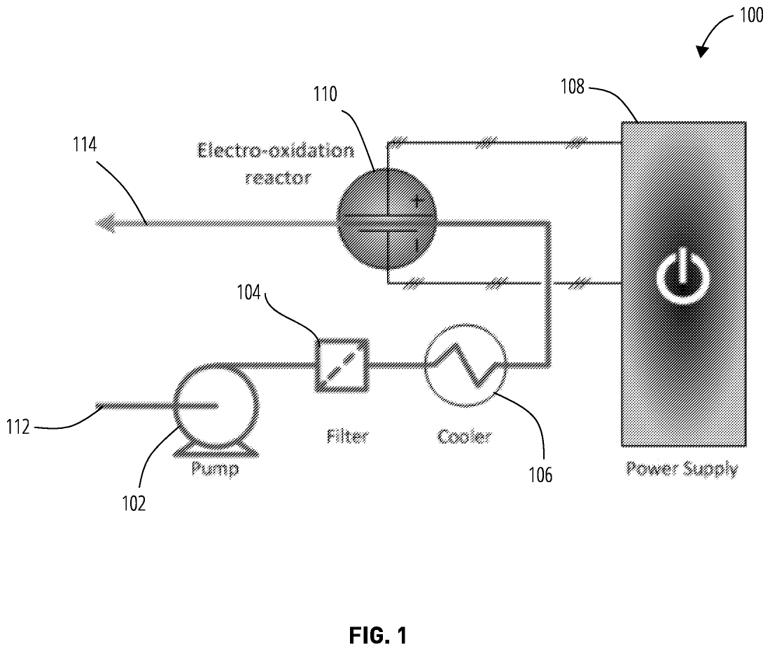

The system of FIG. 1 can be implemented to effectively treat water from natural, industrial, or chemical processes including groundwater, surface water, refineries and petrochemical plants. FIG. 1 illustrates an electro-oxidation system 100 that uses electricity to directly produce hydroxyl radicals in the spent caustic to perform oxidation. The electro-oxidation system 100 illustrated in FIG. 1 includes a pump 102, a filter 104, a cooler 106, a power supply 108, and a reactor 110. Of course, some of the components illustrated in FIG. 1 could be omitted in some systems.

The pump 102, if employed may include any type of pump operable to draw fluid from an intake 112 or source and direct that fluid at a desired flow rate and pressure through the electro-oxidation system 100. A filter 104 may be positioned to filter larger contaminants and debris from the fluid prior to the fluid passing through the cooler 106. The cooler 106 operates to cool the fluid to a desired temperature before the fluid is directed to the reactor 110.

The reactor 110 illustrated in FIG. 1 uses electrically conductive, freestanding, substrate-less, synthetic diamond electrodes to produce hydroxyl radicals directly in the water or fluid, with other arrangements also being possible. Electrical current is provided to the electrode by the power supply 108. Similar to other oxidation technologies, the electrical current completely destroys a portion of the contaminants to their highest oxidation states. The degree of COD (chemical oxygen demand) reduction corresponds directly to the current density and the amount of time the electro-oxidation system 100 is operated. Operating expenses (mainly electricity) are stoichiometrically related to the amount of COD destroyed. The hydroxyl radicals (oxidant) are produced by splitting water into an −OH radical and an H+ ion, using electricity and an electrode. The electro-oxidation system 100 illustrated in FIG. 1 may incorporate one or more boron doped diamond (BDD) electrodes within the reactor 110.

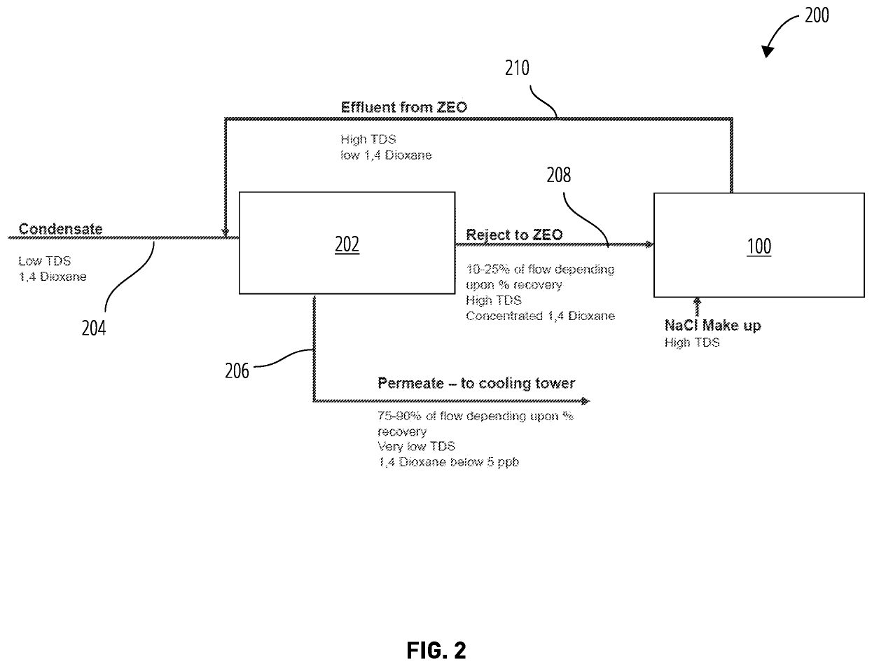

The treatment system 200 of FIG. 2 works in conjunction with the electro-oxidation system 100 of FIG. 1 to further enhance the effectiveness of the contaminant removal. Electro-oxidation of organic compounds is mass transfer limited. In other words, the lower the concentration of the organic contaminant that requires oxidation, the more time and energy (lower efficiency/more expensive) that is required to achieve the desired oxidation. Additionally, low conductivity or non-conductive wastewaters will greatly reduce the electrical efficiency with electro-oxidation.

The treatment system 200 includes the electro-oxidation system 100 and a reverse osmosis system 202. The reverse osmosis system 202 includes one or more membranes that concentrate the salts and contaminants (total dissolved solids (TDS)) in a water flow 204 (input) into a smaller portion of wastewater. This has the effect of increasing the concentration of TDS by five to thirty times the original concentration with a proportional decrease in the volume of water containing the TDS. This allows for the treatment of a much smaller flow of wastewater with a much higher concentration of contaminants, thus improving the efficiency or effectiveness of the electro-oxidation system 100.

In operation, the condensate flow 204 is provided to the reverse osmosis system 202 from a source of wastewater or a process. The reverse osmosis system 202 operates to separate a permeate 206 from a concentrate 208. The permeate 206 has a very low TDS and a very low level of undesirable contaminants and generally includes 75-90 percent of the condensate flow 204. In the example of FIG. 2, the contaminant includes dioxane with the permeate 206 having a level of dioxane below 5 ppb.

The concentrate 208 includes the remainder of the condensate flow 204 (10-25% of the condensate flow 204) and is directed to the electro-oxidation system 100 which operates as described with regard to FIG. 1. In order for the electro-oxidation system 100 to operate, the concentrate 208 must be electrically conductive. To assure this, when needed, salt (e.g., NaCl) is added to the electro-oxidation system 100 via a salt make up salt make-up connection to maintain a desired level of electrical conductivity.

During operation, the electro-oxidation system 100 oxidizes the contaminants to produce a less contaminated fluid and one or more gasses (e.g., carbon dioxide, carbon monoxide, hydrogen, etc.) which can be collected, burned off or simply discharged into the atmosphere. The now reduced contaminant fluid is returned to the condensate flow 204 via an effluent return line 210. The fluid still contains contaminants and when mixed with the condensate serves to increase the contamination level which improves the effectiveness of the treatment system 200.

The conductive salts and untreated contaminants in the effluent return line 210 are thus sent back to the feed side of the reverse osmosis system 202 and reused/re-concentrated for additional treatment in the electro-oxidation system 100.

This treatment system 200 improves the efficiency of the electro-oxidation process, both reducing the amount of time required to accomplish the oxidation and using less electrical power to accomplish the same amount of oxidation. This has the added benefit of allowing smaller equipment sizes for a given task. In addition, as discussed, the non-conductive wastewater requires the addition of an electrically conductive salt, which would normally be sent away with the oxidized effluent. Using membrane separation (reverse osmosis system 202) allows for the salt to be recovered and reused. This lowers the TDS and sulfate to which some downstream wastewater treatment systems are sensitive.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A treatment system operable to treat a flow of water, the treatment system comprising:
a reverse osmosis system operable to separate the flow of water into a permeate that has a first level of a contaminant, and a concentrate that has a second level of the contaminant that is higher than the first level of the contaminant;
an electro-oxidation system positioned to receive the concentrate and operable to reduce the level of the contaminant in the concentrate using an electro-oxidation process and to discharge an effluent having a third level of the contaminant that is lower than the second level of the contaminant; and
an effluent return line positioned to direct the effluent from the electro-oxidation system to an inlet to the reverse osmosis system, the effluent mixing with the flow of water prior to entry into the reverse osmosis system.

2. The treatment system of claim 1, wherein the contaminant includes dioxane and the first level is between 0 and 5 ppb.

3. The treatment system of claim 1, wherein the electro-oxidation system includes a diamond electrode.

4. The treatment system of claim 3, wherein the diamond electrode includes a synthetic boron doped diamond.

5. The treatment system of claim 1, further comprising a salt make-up connection operable to deliver a salt to the electro-oxidation system.

6. A method of treating a quantity of water that is discharged from a process, the method comprising:
mixing the quantity of water with an effluent to produce a condensate;
directing the condensate into a reverse osmosis system;
separating the condensate into a permeate having a first level of a contaminant and a concentrate having a second level of the contaminant that is greater than the first level of the contaminant;
directing the concentrate to an electro-oxidation system;
applying an electrical current to the concentrate to oxidize a portion of the contaminant and generate the effluent having a third level of the contaminant that is lower than the second level of the contaminant; and
directing the effluent to a point upstream of the reverse osmosis system to perform the mixing step.

7. The method of claim 6, further comprising adding a salt to the electro-oxidation system to increase the electrical conductivity of the concentrate.

8. The method of claim 7, removing a portion of the salt from the effluent in the reverse osmosis system and redirecting a portion of the removed salt to the electro-oxidation system to maintain a desired level of electrical conductivity of the concentrate.

9. The method of claim 6, wherein the applying the electrical current step further comprises applying the electrical current through a diamond electrode.

10. The method of claim 9, wherein the diamond electrode includes a synthetic boron doped diamond.

11. The method of claim 6, wherein the contaminant includes dioxin and wherein the first level of dioxin of between 0 and 5 ppb.

12. A method of treating a quantity of water that includes a first level of a contaminant and that is discharged from a process, the method comprising:
mixing the quantity of water with an effluent having a second level of the contaminant to produce a condensate having a third level of contaminant, the second level being greater than the first level;
passing the condensate through a reverse osmosis system to produce a permeate having a fourth level of the contaminant and a concentrate having a fifth level of the contaminant that is greater than the fourth level;
oxidizing the concentrate in an electro-oxidation system to generate the effluent; and
directing the effluent to a point upstream of the reverse osmosis system to perform the mixing step.

13. The method of claim 12, wherein the oxidizing step further comprises applying an electrical current to the concentrate to oxidize a portion of the contaminant.

14. The method of claim 13, wherein the applying the electrical current step further comprises applying the electrical current through a diamond electrode.

15. The method of claim 14, wherein the diamond electrode includes a synthetic boron doped diamond.

16. The method of claim 12, further comprising adding a salt to the electro-oxidation system to increase the electrical conductivity of the concentrate.

17. The method of claim 16, further comprising removing a portion of the salt from the effluent in the reverse osmosis system and redirecting a portion of the removed salt to the electro-oxidation system to maintain a desired level of electrical conductivity of the concentrate.

18. The method of claim 12, wherein the contaminant includes dioxin and wherein the second level of dioxin is between 0 and 5 ppb.

19. The method of claim 12, wherein the level of contaminant drops from a highest level to a lowest level in the following order: fifth level, second level, third level, first level, and fourth level.
